(19) United States
(12) Patent Application Publication
(10) Pub. No.: US 2008/0148368 A1
(43) Pub. Date: Jun. 19, 2008

(54) SECURE EXTRANET ACCESS TO COLLABORATIVE ACTIVITIES IN A COLLABORATIVE COMPUTING ENVIRONMENT

(76) Inventors: Mary Ellen Zurko, Groton, MA (US); David E. Wilson, Lowell, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/610,787

(22) Filed: Dec. 14, 2006

(51) Int. Cl. H04L 9/32

(52) U.S. Cl. 726/5

(57) ABSTRACT

Embodiments of the present invention address deficiencies of the art in respect to securing extranet access to a collaborative environment and provide a method, system and computer program product for secure extranet access to collaborative activities in a collaborative environment. In an embodiment of the invention, a method for secure extranet access to collaborative activities in a collaborative environment can be provided. The method can include adding an extranet collaborator to a collaborative space within a collaborative environment and establishing encryption credentials for the extranet collaborator. Thereafter, in response to detecting a change to the collaborative space, the change can be encrypted with the credentials and the change can be messaged to the extranet collaborator. Notably, a contribution to the activity can be received from the extranet collaborator. Once received, the contribution can be decrypted with the credentials and the contribution can be posted to the activity.

### BACKGROUND OF THE INVENTION

1. Field of the Invention

The present invention relates to the field of collaborative computing and more particularly to secure access in a collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Modern collaboration tools combine e-mail with other functions to integrate e-mail seamlessly into end user daily activities in an activity-centric collaboration tool. Activity-centric collaboration tools recognize that it is not enough to help people manage their e-mail, but to help people manage their work by associating communications and information feeds around a topic or activity. In an activity-centric collaboration tool, e-mail messages, synchronous communication such as instant messages, screen images, files, folders and to-do lists can be combined into an activity thread by a team allowing the team to switch easily between asynchronous and real-time collaboration. In this regard, an activity thread might include the messages, chats and files exchanged among members of a team participating in a group project.

Collaborative computing often requires the participation of collaborators outside of the immediate environment within a different enterprise, or outside of the host enterprise. In the collaborative environment it is desirable to allow administrators of a collborative space to authorize select collaborators to access a designated collaborative space while authenticating the authorized collaborators into the designated collaborative space and also while constraining the authorized collaborators to the designated collaborative space. In many sophisticated enterprise implementations, federated identity management handles universal authentication for users into the enterprise and then to supported applications hosted within the enterprise. Supporting federated identity for a collaborative environment, however, can be complicated and expensive for many organizations. Other solutions include outsourcing authentication to an external authority beyond the enterprise. Many organizations, however, prefer not to lose control of the authentication process through external outsourcing of identity management and require the parallel authentication of extranet users into the collaborative environment.

### BRIEF SUMMARY OF THE INVENTION

Embodiments of the present invention address deficiencies of the art in respect to securing extranet access to a collaborative environment and provide a novel and non-obvious method, system and computer program product for secure extranet access to collaborative activities in a collaborative environment. In an embodiment of the invention, a method for secure extranet access to collaborative activities in a collaborative environment can be provided. The method can include adding an extranet collaborator to a collaborative space within a collaborative environment and establishing encryption credentials for the extranet collaborator. Thereafter, in response to detecting a change to the collaborative space, the change can be encrypted with the credentials and the change can be securely messaged to the extranet collaborator. Notably, a contribution to the activity can be received from the extranet collaborator, for instance by way of e-mail, instant messaging or even in by way of publishing in an automated feed such as a really simple syndication (RSS) feed. Once received, the contribution can be decrypted with the credentials and the contribution can be posted to the activity.

In another embodiment of the invention, a collaborative computing data processing system can be provided. The system can include a collaborative environment configured for coupling both to internal collaborators over an internal computer communications network, and also to extranet collaborators over an external computer communications network The system further can include a credentials store for the extranet collaborators, a messaging service coupled to the collaborative environment, and secure extranet access logic coupled to the collaborative environment. The logic can include program code enabled to establishing encryption credentials for the extranet collaborators and, in response to detecting a change to a collaborative space in the collaborative environment, to encrypt the change with associated credentials in the credentials store and to message the change to the extranet collaborator through the messaging service.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative application data processing system configured for secure extranet access to collaborative activities;

FIG. 2 is a flow chart illustrating a process for applying credentials for secure extranet access to collaborative activities in a collaborative environment; and,

FIGS. 3A and 3B, taken together, are a flow chart illustrating a process for secure extranet access to collaborative activities in a collaborative environment.

### DETAILED DESCRIPTION OF THE INVENTION

Embodiments of the present invention provide a method, system and computer program product for secure extranet access to collaborative activities in a collaborative environment. In accordance with an embodiment of the present invention, extranet collaborator can be invited to a new activity in the collaborative computing environment. If the extranet collaborator has not yet been authenticated, secure credentials can be issued to the extranet collaborator. Thereafter, new entries to the activity can be encrypted according to the issued credentials and messaged to the extranet collaborator, for example using e-mail. Likewise, contributions by the extranet collaborator can be encrypted according to the issued credentials and messaged to an authorized collaborator within the enterprise for addition to the activity. In this way, the extranet collaborator can participate in the activity without close coupling the extranet collaborator to federated identity management within the enterprise.

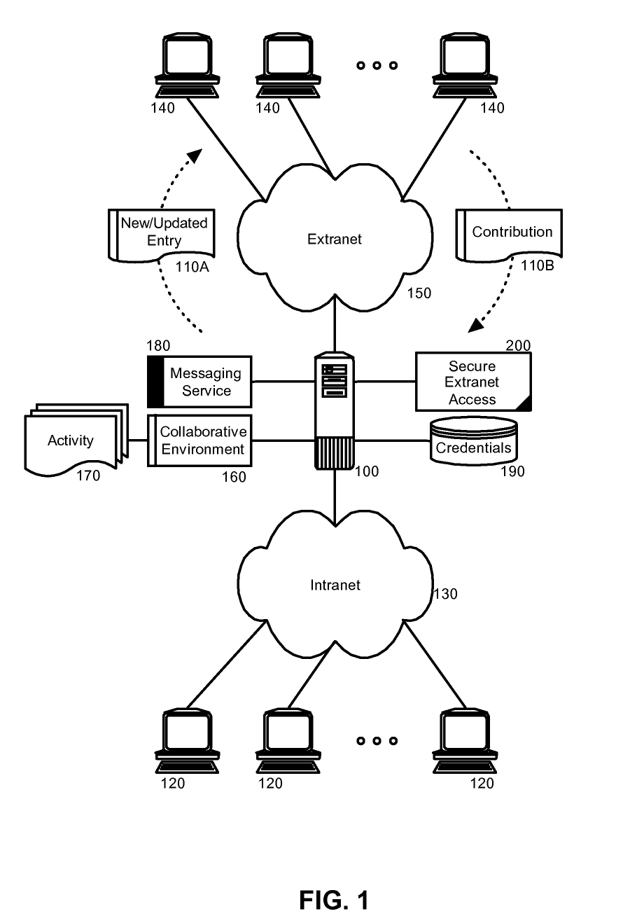

In further illustration, FIG. 1 is a schematic illustration of a collaborative application data processing system configured for secure extranet access to collaborative activities. The system can include a host computing platform 100 supporting the subsistence of a collaborative environment 160. The collaborative environment 160 can manage one or more activities 170 so as to permit activity-centric collaboration among one or more internal collaborators 120 coupled to the host computing platform 100 over an internal computer communications network 130 defining the enterprise. Notably, secure extranet access logic 200 can be coupled to the collaborative environment 160.

The secure extranet access logic 200 can include program code enabled to provide secure extranet access to one or more of the activities 170 on behalf of one or more external collaborators 140 coupled to the host computing platform 100 over an external computer communications network 150. In this regard, the program code can be enabled to establish secure credentials 190 for each of the external collaborators 140. Thereafter, new and updated entries 110A to the activities 170 can be securely messaged utilizing the secure credentials 190 to corresponding ones of the external collaborators 140 by way of a coupled messaging service 180, for example an e-mail server. Likewise, contributions 110B from the external collaborators 140 can be received by way of the messaging service 180 and accessed utilizing the secure credentials 190 for addition to the corresponding ones of the activities 170.

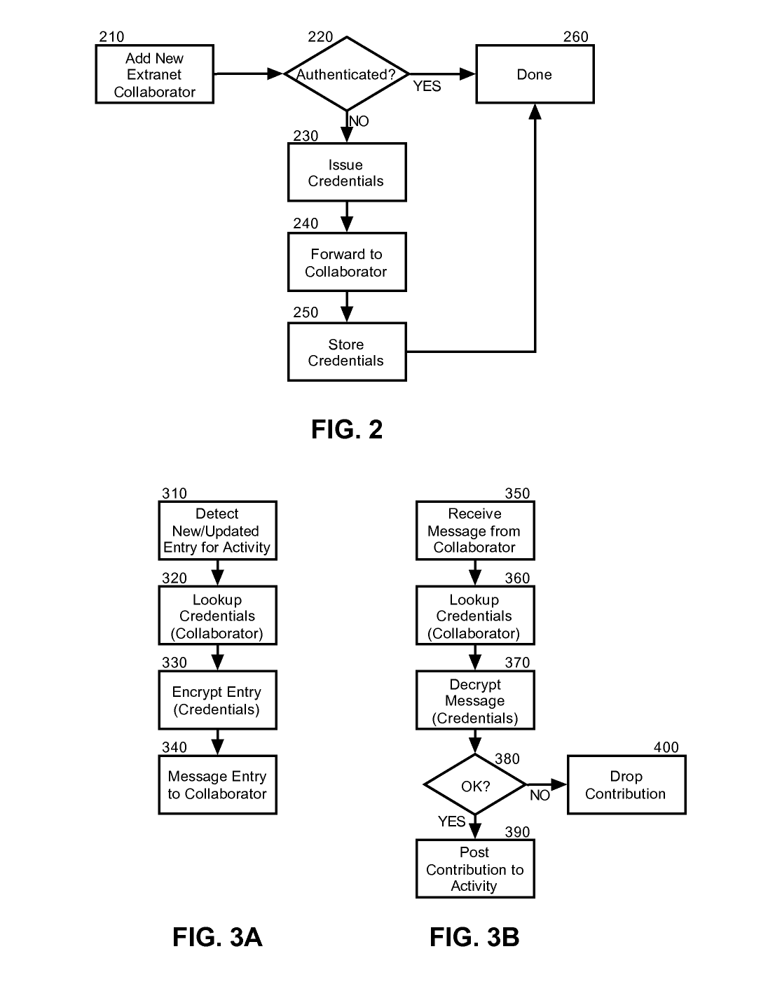

Prior to managing secure extranet access to an activity 170 for an external collaborator 140, first credentials 190 must be established for the external collaborator. In further illustration, FIG. 2 is a flow chart illustrating a process for applying credentials for secure extranet access to collaborative activities in a collaborative environment. Beginning in block 210, a new extranet collaborator can be added to an activity in the collaborative environment. In decision block 220, it can be determined whether or not credentials previously have been issued for the new extranet collaborator, for example if the a public key has been stored in association with new extranet collaborator to securely access activities in the collaborative environment.

In decision block 220, if it is determined that the new extranet collaborator already has been authenticated so as to include credentials stored for the new extranet collaborator, in block 260 the process can end. Otherwise, credentials can be issued to the new extranet collaborator in block 230. For instance, in block 230 a key pair can be generated for the new extranet collaborator, the key pair including both public and private keys for the extranet collaborator. Thereafter, in block 240, the credentials can be forwarded to the new extranet collaborator and in block 250, the credentials also can be stored in association with the new extranet collaborator. In this regard, the new extranet collaborator can be prompted to forward a public key portion of a key pair. Finally, in block 260 the process can end.

Once credentials have been established for an external collaborator, the external collaborator can be notified of new activity changes and the external collaborator can provide contributions to associated activities from outside the enterprise. In yet further illustration, FIGS. 3A and 3B, taken together, are a flow chart illustrating a process for secure extranet access to collaborative activities in a collaborative environment. Beginning in block 310 of FIG. 3A, a new or updated entry for an activity can be detected. Thereafter, external collaborators participating in the activity can be identified and in block 320, the credentials for the external collaborators can be located. In block 330, the new or updated entry for the activity can be encrypted according to the credentials for the external collaborators. Finally, in block 340 the new or updated entry in encrypted form can be messaged to the external collaborators, for instance using e-mail.

Each of the extranet collaborators to an activity can provide contributions to the activity in a secure manner from outside the enterprise. Specifically, beginning in block 350 of FIG. 3B, a message can be received from an extranet collaborator for an associated activity. The message, for example an e-mail, can include a payload authenticated or signed according to the credentials of the extranet collaborator and optionally encrypted with the credentials of the receiving system. Consequently, in block 360 the credentials for the extranet collaborator can be located and in block 370, the message payload can be authenticated accordingly. Once decrypted, the contribution can be reviewed, for example by an administrative collaborator or automated system and, in decision block 380, if it is determined to post the contribution, in block 390 the contribution can be posted to the activity. The contribution may be attributed to the identity of the extranet collaborator if the system is flexible enough to propagate that identity. Otherwise, in block 400 the contribution can be discarded.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for secure extranet access to collaborative activities in a collaborative environment, the method comprising:
adding an extranet collaborator to a collaborative space within a collaborative environment;
establishing authentication credentials for the extranet collaborator; and, responsive to detecting a change to the collaborative space, protecting the change with the credentials and securely messaging the change to the extranet collaborator.

2. The method of claim 1, wherein adding an extranet collaborator to a collaborative space within a collaborative environment, comprises adding an extranet collaborator to an activity for a collaborative space within a collaborative environment.

3. The method of claim 1, wherein establishing encryption credentials for the extranet collaborator, comprises:
prompting the extranet collaborator to acquire a public/private encryption key pair; and,
storing a public key for the key pair in association with the extranet collaborator within the collaborative environment.

4. The method of claim 2, wherein encrypting the change with the credentials, comprises encrypting one of a new or updated entry to the activity with the credentials.

5. The method of claim 3, wherein encrypting the change with the credentials, comprises encrypting the change with the public key.

6. The method of claim 2, wherein messaging the change to the extranet collaborator, comprises one of e-mailing, instant messaging or publishing within an automated feed the change to the extranet collaborator.

7. The method of claim 2, further comprising:
receiving a contribution to the activity from the extranet collaborator;
decrypting the contribution with the credentials; and, posting the contribution to the activity.

8. The method of claim 7, wherein posting the contribution to the activity, comprises:
determining whether or not to post the contribution to the activity from within the collaborative environment; and,
posting the contribution to the activity only when it is determined to post the contribution to the activity.

9. A collaborative computing data processing system comprising:
a collaborative environment configured for coupling both to a plurality of internal collaborators over an internal computer communications network, and also to a plurality of extranet collaborators over an external computer communications network;
a credentials store for the extranet collaborators;
a messaging service coupled to the collaborative environment; and, secure extranet access logic coupled to the collaborative environment, the logic comprising program code enabled to establishing authentication credentials for the extranet collaborators and, in response to detecting a change to a collaborative space in the collaborative environment, to protect the change with associated credentials in the credentials store and to message the change to the extranet collaborator through the messaging service.

10. The system of claim 9, wherein credentials store comprises public keys corresponding to respective ones of the extranet collaborators.

11. The system of claim 9, wherein the collaborative environment comprises a plurality of activities.

12. The system of claim 9, wherein the messaging service is an e-mail server.

13. A computer program product comprising a computer usable medium embodying computer usable program code for secure extranet access to collaborative activities in a collaborative environment, the computer program product comprising:
computer usable program code for adding an extranet collaborator to a collaborative space within a collaborative environment;
computer usable program code for establishing encryption credentials for the extranet collaborator; and,
computer usable program code for encrypting the change with the credentials and messaging the change to the extranet collaborator in response to detecting a change to the collaborative space.

14. The computer program product of claim 13, wherein the computer usable program code for adding an extranet collaborator to a collaborative space within a collaborative environment, comprises computer usable program code for adding an extranet collaborator to an activity for a collaborative space within a collaborative environment.

15. The computer program product of claim 13, wherein the computer usable program code for establishing encryption credentials for the extranet collaborator, comprises:
computer usable program code for prompting the extranet collaborator to acquire a public/private encryption key pair; and,
computer usable program code for storing a public key for the key pair in association with the extranet collaborator within the collaborative environment.

16. The computer program product of claim 14, wherein the computer usable program code for encrypting the change with the credentials, comprises computer usable program code for encrypting one of a new or updated entry to the activity with the credentials.

17. The computer program product of claim 15, wherein the computer usable program code for encrypting the change with the credentials, comprises computer usable program code for encrypting the change with the public key.

18. The computer program product of claim 14, wherein the computer usable program code for messaging the change to the extranet collaborator, comprises computer usable program code for e-mailing the change to the extranet collaborator.

19. The computer program product of claim 14, further comprising:
computer usable program code for receiving a contribution to the activity from the extranet collaborator;
computer usable program code for decrypting the contribution with the credentials; and, computer usable program code for posting the contribution to the activity.

20. The computer program product of claim 19, wherein the computer usable program code for posting the contribution to the activity, comprises:
computer usable program code for determining whether or not to post the contribution to the activity from within the collaborative environment; and,
computer usable program code for posting the contribution to the activity only when it is determined to post the contribution to the activity.
